(19) United States
(12) Patent Application Publication
(10) Pub. No.: US 2008/0208254 A1
(43) Pub. Date: Aug. 28, 2008

(54) Sucking and Chewing Article for Babies or Small Children

(76) Inventors: Steffen Berger, Zeven (DE); Alexander DuChesne, Heeslingen (DE); Gunter Marr, Rosengarten (DE)

Correspondence Address: THELEN REID BROWN RAYSMAN & STEINER LLP, P.O. BOX 640640, SAN JOSE, CA, 95164-0640, US

(21) Appl. No.: 11/994,117

(22) PCT Filed: Jun. 15, 2006
(86) PCT No.: PCT/EP2006/063245

§ 371 Date: Dec. 27, 2007

(30) Foreign Application Priority Data
Jul. 6, 2005 (DE) 20 2005 011 043.4

(51) Int. Cl. A61J 17/00; A61J 17/02

(52) U.S. Cl. 606/235; 606/236; 606/234

(57) ABSTRACT

The invention relates to a suction or chewing article for babies or small children comprising at least one mouthpiece made of a substantially elastomer material containing at least one elastomer component. According to said invention, the elastomer material contains at least one type of liquid crystal pigment (LC-pigment).

The invention relates to sucking and chewing articles for babies or small children, said articles comprising at least one mouthpiece consisting of an essentially elastomeric material that contains at least one elastomer component.

Sucking and chewing articles for babies and small children have been known. They include, for example, suckers such as pacifier suckers (“binkies”) or feeding suckers that can be attached to drinking bottles, or drinking spouts, or solid chew articles such as bite rings or related products. For example, various suckers for babies and small children have been known from literature references DE-U-9415655, DE-U-29510460, DE-U-20007609, DE-C-3232101, DE-C-3241845, DE-C-3347876 and DE-C-4229224.

Each of the aforementioned articles comprises at least one mouthpiece that is intended to be taken into the mouth by the child for the purpose of sucking and/or chewing. Referring to suckers, for example, the mouthpiece consists of a rubber-elastic nipple that is held by a harder mouth shield (in the case of pacifier nipples) or by a bottle attachment (in the case of feeding nipples). In the case of objects intended strictly for biting, such as bite rings and the like, the mouthpiece frequently accounts for the entire article, without other parts being present. Basically, the mouthpiece is made of a material displaying essentially elastic properties, said material containing one or more elastomers, typically cross-linked latex.

Considering all of these products, it must be avoided that a child will bite off pieces of the elastic mouthpiece so as to prevent undesirable swallowing. In view of the considerable mechanical stress occurring when these articles are used as intended, the expectations of the material properties, in particular the tearing strength, must be high and are frequently regulated by law. On the other hand, all content substances must, of course, satisfy strict toxicological requirements, and a migration and release of content substances must be safely prevented. It is true, additives effecting an increase in strength have been known in polymer chemistry, however, admixing them to the elastomers in the present application is frequently not permissible.

On the other hand, the incorporation of liquid crystalline pigments (LC pigments) has been known in predominantly thermoplastic synthetic material matrices for paints, coatings, films and the like (DE-C-441890, DE-C-19639179, EP-B-0758362, EP-B-0758363, EP-B-0887398). LC pigments comprise one or more essentially colorless LC compounds having the properties of liquid crystals that are “frozen” in ordered state (nematically, smectically, cholesterically, discotically) by being cross-linked. LC pigments are essentially colorless, i.e., they do not display any color due to light absorption effects. Rather, LC pigments, due to the diffraction of light, impart the materials with color effects depending on the viewing angle, said effects being, in particular, angle-dependent color changes (“color flops”). Document DE-A-19917067 describes LC pigments displaying a chiral phase for effect coatings. The LC pigment comprises a mixture of a rod-shaped polymerizable compound and of a chiral compound that can also be polymerized. The mixture is spread by a doctor blade or by a roller in order to form a film and, in so doing, is oriented, in which case, due to the chiral constituents, a helical superstructure is formed. In this liquid-crystalline state, the compounds are cross-linked in three dimensions and the ordered structure is frozen, as it were. The thusly produced film is ground into platelet-shaped pigment particles that are added to the appropriate coating materials. Document US 2004 023993 A describes the use of such acrylate-based LC pigments in decorative body care products, said products resulting in a glitter effect on the skin.

The object to be achieved by the present invention is to provide sucking and chewing articles for babies or small children, said articles displaying improved tearing strength. In so doing, the articles are to be food grade, i.e., they must not constitute a health hazard when in contact with foodstuffs.

This object is achieved with the sucking and chewing articles displaying the features of Claim 1. The articles in accordance with the invention comprise at least one mouthpiece of a material having essentially elastomeric properties (elastomeric material), which contains a liquid crystalline pigment (LC pigment) in addition to at least one elastomer component. Surprisingly, it has been found that, by admixing LC pigments to the polymer material used for the production of the elastomeric material, a significant increase of the tearing strength is achieved. In so doing, the LC pigments—despite having a polarity different from the matrix polymer—do not indicate any tendency whatsoever of separating from the matrix material in migration testing, thus only now making possible the use of the articles in accordance with the invention.

In addition, the basically colorless LC pigments provide the elastomeric with appealing optical effects that may vary greatly, depending on the matrix polymer and the type of LC pigments. In particular, LC pigments are preferably selected in such a manner that a color-donning and/or reflecting optical effect (glitter effect) results, whereby the color impression varies with the angle of incidence of light and with the viewing angle. In so doing, as is usual with liquid crystals, the color impression is achieved not only by the absorption of certain wavelengths but also by the diffraction and interference phenomena on the quasi-crystalline lattice structure of the LC pigment. Considering a typically non-planar, rather complex three-dimensional embodiment of the inventive article or of the mouthpiece, interesting color flops thus result in rounded regions, even from a fixed viewing position. Surprisingly, the optical effects not only occur in the case of transparent materials such as silicone but also in non-transparent materials such as latex. In accordance with an advantageous embodiment in accordance with the invention, the optical effect is even enhanced and/or varied in that the elastomeric material of the mouthpiece of the article contains —besides the LC pigment—one or more additional color pigments and/or dyes which, of course, must satisfy the aforementioned requirements of foodstuff safety.

It is possible to add the LC pigments to the elastomeric material in a wide concentration range. Below a mass fraction w of 0.01% by weight, the strength-improving effect (and also the optical effect) is minimal, however; whereas above 10%, undesirable material properties may come to the foreground. In particular, the mass fraction of the LC pigment in the elastomeric material of the mouthpiece is at 0.1% to 5%, preferably at approximately 0.5% to 1%.

LC pigments contain one or more liquid crystalline compounds, i.e., substances which adopt an at least partially ordered structure in their liquid phase. In particular, considering rod-shaped molecules, a distinction is made among nematic (parallel orientation of the molecular axes), smectic (parallel orientation in the layers/stacks), and cholesteric phases (helical superstructure based on the continuous twisting of the molecular axis). While the helical superstructure of the cholesteric phase can be achieved only by chiral molecules, helical superstructures may also be induced in smectic or nematic phases in that chiral compounds (chiral phases) are added. Within the framework of the present invention, helical structures are particularly preferred because of their particularly interesting optical effects.

Fundamentally, an aligned orientation of the liquid crystalline compound can occur during the production of the article in accordance with the invention, for example, as a result of shearing forces that occur during injection molding or immersion processes. However, preferably used are LC pigments, which contain the liquid crystalline compound in already at least partially oriented form and in which the ordered structure is “frozen”, as it were, and is thus irreversible due to three-dimensional cross-linking or due to cross-linked polymerization. For example, the LC pigments described in document DE 199 17 067 A can be used in this case.

Referring to the present invention, the terms “elastomer” and “elastomer component” are understood to mean a polymer displaying rubber-elastic behavior, i.e., it has the ability to reversibly stretch to twice its length at room temperature and, after discontinuing the application of the elongation forces, to spontaneously return—at least approximately—to its original shape. Elastomers are wide-mesh cross-linked high-polymer materials, whereby cross-linking can be irreversibly achieved via covalent chemical bonds or physically, and thus can be achieved in a mostly reversible manner. Consistent with the purpose of the products in accordance with the invention, the minimum of one elastomer is preferably selected from the following elastomer classes: latices (in particular natural latices), solid rubber mixtures based on natural and synthetic rubbers, silicone elastomers, thermoplastic elastomers (TPE), or mixtures thereof. From among these, materials that are suitable for, or have been approved for, contact with foodstuffs are selected.

In so doing, “latex” is generally understood to be a colloidal dispersion of polymers in aqueous media of natural or synthetic origin. The “natural latices” that are of particular interest in conjunction with the present invention are those comprised by the generic term for plant-based products, namely the white plant milk of various plants, in particular that of rubber-trees. Natural latex is an emulsion of natural rubber droplets (i.e., 1,4-cis- or rather 1,4-trans-polyisoprene) having a size of approximately 0.5 to 1 μm in water, whereby said emulsion may additionally contain proteins, sterins, lipids, carbohydrates and mineral constituents. The composition varies depending on the plant. Particularly preferred are 1,4-cis-polyisoprene natural latices.

In the present case, the “solid rubber mixtures” are understood to be systems on the basis of solid rubbers that are cross-linked (cured) when processed. In conjunction with the present invention, natural rubbers as well as synthetic rubbers or systems derived therefrom can be considered. “Natural rubber” is a solid material usually yielded by coagulation from natural latex (see above), said material essentially containing 1,4-cis- or 1,4-trans-polyisoprene (and optionally also traces of the other latex constituents). By cross-linking with a suitable cross-linker, for example sulfur, the insoluble product is solid rubber that can no longer be thermoplastically processed. The term “synthetic rubbers” comprises synthetically produced polymers, as well as the isoprene (2-methyl-buta-1,3-diene), which thus have the same composition as natural rubber, and also comprises polymers of other 1,3-dienes. The latter, for example, include methyl rubber (of 2,3-dimethyl-1,3-butadiene), polybutadiene (of 1,3-butadiene) and polymers that are yielded by copolymerization or terpolymerization of two or three different monomers. Particularly preferred rubbers in conjunction with the present invention comprise natural 1,4-cis-polyisoprene (natural rubber) and synthetic 1,4-cis-polyisoprene.

“Thermoplastic elastomers” (TPE) possess a combination of the utilization properties of elastomers and the processing properties of thermoplastic materials. This means that TPEs can be elastically deformed and can be thermally melted and processed. This is achieved in that the polymer chain contains soft and hard segments that are not compatible with each other, thus resulting in a micro-separation. In so doing, the soft segments display elastic properties such as a high stretching ability, and a low glass transition temperature, while the crystallizable hard segments display a low stretching ability and a high glass transition temperature, and—in most cases by forming associates—cross-link physically (reversibly).

Important TPE classes are, for example: olefin-based thermoplastic elastomers (TPO); thermoplastic natural rubbers (TP-NR, soft segment=cross-linked natural rubber; hard segment=polypropylene); thermoplastic silicone rubbers (TP-Q); styrene triblock copolymers, for example, SBS (butadiene/styrene); SIS (isoprene/styrene), and SEBS (ethylene butylene/styrene); thermoplastic polyurethanes (TPU, ester or ether glycols/isocyanates); copolymeric polyether esters (CPE, CPA); (polyether block amides (PEBA, ether diols/amides). With the exception of the TPU that is less suitable in the present field of application, all other of the aforementioned TPE classes can be used in accordance with the invention.

“Silicones” are synthetic polymers having a fundamental structure of silicone atoms that are linked in a chain-like and/or net-like manner via the oxygen atoms. The remaining silicone valences are saturated via hydrocarbon radicals (mostly methyl groups). In conjunction with the present invention, those “silicone elastomers” (silicone rubbers), which are yielded by cross-linking (hardening) silicone rubbers are taken into consideration. Silicone rubbers contain polydiorganosiloxanes with cross-linkable groups (e.g., H atoms, OH or vinyl groups) as their fundamental polymers and can be converted into rubber-elastic state by cross-linking. A distinction is made between hot-hardened (HTV) and cold-hardened (RTV) silicone rubbers. In accordance with the invention, preferred HTV types are one-component systems of highly disperse silicic acid, which are hardened with suitable cross-linking catalysts at temperatures above 100° C. (solid silicones). Also advantageous are two-component systems which are processed by liquid rubber technology (LSR=liquid silicone rubber). In so doing, two liquid HTV silicone rubber components are hardened via addition cross-linking in an automatic injection molding machine. Likewise, one-component and two-component systems are also known in conjunction with RTV silicone rubbers. Referring to the present invention, one-component or two-component HTV systems are preferred.

Considering the present invention, it is possible, on the one hand, that the entire elastomeric material of the mouthpiece contains the minimum of one LC pigment in an almost homogenous distribution. In accordance with an alternative embodiment, however, it is also conceivable that the elastomeric material contains the LC pigment only in specific areas, i.e., in partial areas. In particular, the LC pigment may be contained only in one or in several individual layers. In this manner, a mouthpiece that has been manufactured in a multi-cycle immersion process may contain the LC pigment in only the outermost, last-produced layer. In this manner, in fact exactly the most mechanically stressed layer is reinforced in accordance with the invention and, at the same time, displays the advantageous optical effect.

Preferably, the article is a sucker, in particular, a pacifier or a food nipple, a drinking spout, a bite ring or the like, i.e., an article that is intended for the partial accommodation in the mouth, optionally for contact with foodstuffs, however, not for consumption. Accordingly, another aspect of the present invention relates to the use of LC pigments in elastomeric materials for mouthpieces of the said articles.

Hereinafter, the invention is explained in detail with reference to exemplary embodiments:

### EXAMPLE 1

### Latex Sucker

An amount of 1 percent by weight of acrylate-based LC pigment (Helicone HC, Wacker-Chemie GmbH) was added to a natural latex mixture consisting of raw latex containing approximately 60% of DRC (dry rubber content, rubber content), approximately 1.9 phr (parts per 100 parts of rubber) of sulfur (cross-linker), 0.4 phr of dibenzyl-dithiocarbamate (hardening accelerator), 0.4 phr of ZnO (acceleration activator) and 0.3 phr of 1,2′-methylene-bis-(4-methyl-6-tert-butylphenol) (anti-aging agent).

This mixture was used for the manufacture of suckers in a multi-cycle immersion process. For comparison, suckers were manufactured in the same manner, however, without the addition of LC pigment.

The thusly produced suckers—like the reference suckers that do not contain LC pigment—are not transparent. However, compared with the usual latex-yellow coloration of the reference suckers, the suckers in accordance with the invention are shimmering with a golden coloration.

### EXAMPLE 2

### Silicone Sucker

A two-component HTV solid silicone mixture (50:50) (Elastosil R plus 4000, Wacker-Chemie GmbH) was mixed with a cross-linking catalyst (Pt) and with 0.5% by weight of an acrylate-based LC pigment (Helicone HC, Wacker-Chemie GmbH).

This mixture was used to produce suckers at a tool temperature of 165° C. in an automatic injection molding machine. For comparison, suckers were manufactured in the same manner, however, without LC pigment.

These thusly manufactured suckers—like the reference suckers without LC pigment—are transparent. Different from the reference suckers, the suckers in accordance with the invention, however, displayed a glitter effect, as well as a pigment-dependent effect that varies, among other things, with the angle of incidence or light and with the viewing angle.

### EXAMPLE 3

### TPE Drinking Spouts

TPE material of the type Cawiton PR 1088C (Wittenburg B. V., Netherlands) was reacted with 0.5% by weight of acrylate-based LC pigment (Helicone HC, Wacker-Chemie GmbH).

This mixture was used for the manufacture of drinking spouts.

In incident light, the drinking spouts displayed a glitter effect, whereby the imparted color depended on the angle of the incident light and on the viewing angle.

### Tearing Strength Test

The tearing strength of the inventive article in accordance with Examples 1 through 3 was determined with a Zwick tester and compared with the tearing strength of the reference articles without LC pigment. In so doing, the inventive articles displayed a tearing strength that is by up to 10% higher than that of the reference suckers. This effect can be enhanced even more the longer the article is stored.

### Migration Behavior Test

Migration tests (global migration in accordance with the German Foodstuffs and Commodities Act [Lebensmittel—und Bedarfsgegenständegesetz—LMBG]) were performed on the inventive article in accordance with Examples 1 through 3, whereby the release of LC pigments as a result of unmixing was investigated. Surprisingly, the release of pigments could not be verified in any case, despite the polarity differences between the LC pigments and the respective matrix polymers. This means that the LC pigments remain in the materials, this being the prerequisite for their use in materials that come into contact with foodstuffs.

1. Sucking and chewing article for babies or small children, said article comprising at least one mouthpiece of an essentially elastomeric material that contains at least one elastomer component,
wherein
the elastomeric material contains at least one liquid crystalline pigment (LC pigment).

2. The article of claim 1,
wherein
the mass fraction (w) of the minimum of one LC pigment in the elastomeric material is from 0.01% to 10%, in particular from 0.1% to 5%, preferably from 0.5% to 1%.

3. The article of claim 1,
wherein
the minimum of one LC pigment comprises at least one liquid crystalline substance which is present in an at least partially ordered structure, in particular, in a helical superstructure.

4. The article of claim 3,
wherein
the minimum of one liquid crystalline substance has a chiral phase.

5. The article of claim 3,
wherein
the minimum of one liquid crystalline substance is present in three-dimensionally cross-linked form.

6. The article of claim 1,
wherein
the minimum of one LC pigment imparts the elastomeric material with an optical effect, in particular, a color-donning and/or reflecting effect.

7. The article of claim 1,
wherein
the minimum of one elastomer component is selected from the group comprising latices, in particular natural latices, solid rubber mixtures based on natural or synthetic rubbers, silicone elastomers, thermoplastic elastomers (TPE), or mixtures thereof.

8. The article of claim 1,
wherein
besides the minimum of one LC pigment, the elastomeric material contains at least one color pigment and/or dye.

9. The article of claim 1,
wherein
the total elastomeric material contains the minimum of one LC pigment.

10. The article of claim 1,
wherein
the elastomeric material contains the minimum of one LC pigment only in specific regions, in particular in individual layers.

11. The article of claim 1,
wherein
the article is manufactured by an injection molding process or by an immersion process.

12. The article of claim 1,
wherein
the article is a sucker, in particular a pacifier sucker or feeding sucker, a drinking spout, a bite ring or the like.

13. The article of claim 1,
wherein
the article, in particular the mouthpiece, has a non-planar three-dimensional shape.
